(19) United States
(12) Patent Application Publication
(10) Pub. No.: US 2014/0207644 A1
(43) Pub. Date: Jul. 24, 2014

(54) AUTOMATIC FINANCIAL INSTRUMENT TRANSACTION SYSTEM

(71) Applicant: BGC PARTNERS, INC., New York, NY (US)

(72) Inventors: Howard W. Lutnick, New York, NY (US); Michael Sweeting, London (GB); Joseph C. Noviello, Summit, NJ (US)

(73) Assignee: BGC PARTNERS, INC., New York, NY (US)

(21) Appl. No.: 14/087,911

(22) Filed: Nov. 22, 2013

Related U.S. Application Data
(63) Continuation of application No. 12/014,027, filed on Jan. 14, 2008, now abandoned.
(60) Provisional application No. 61/020,374, filed on Jan. 10, 2008.
(60) Provisional application No. 61/020,138, filed on Jan. 9, 2008.

(51) Int. Cl. G06Q 40/04

(52) U.S. Cl. CPC G06Q 40/04
USPC 705/37

(57) ABSTRACT

A computer-based transaction system manages representations of a plurality of positions in a first type of financial instrument, such as bond future contracts. The transaction system, at a first predetermined time, converts each position in the first type of financial instrument into a corresponding position in a second type of financial instrument, such as bonds. At a second predetermined time that is after the first predetermined time, the transaction system converts each position in the second type of financial instrument into a position in the first type of financial instrument.

This application is a continuation of U.S. application Ser. No. 12/014,027, filed Jan. 14, 2008, which is a nonprovisional of U.S. Provisional App. Ser. No. 61/020,374, filed Jan. 10, 2008 and U.S. Provisional App. Ser. No. 61/020,138, filed Jan. 9, 2008. Each is incorporated by reference.

### BACKGROUND

This application relates to computer trading systems for financial instruments.

### DESCRIPTION OF THE DRAWINGS

FIG. 1 is a diagram of entities in a transaction system.

FIG. 2 is a diagram of states in a transaction system.

FIG. 3 is a display from a system.

FIG. 4 is another display.

FIG. 5 is another display.

FIG. 6 is another display.

### DESCRIPTION

The Description generally is organized as follows.
I. Overview
II. Further Details and Alternatives
   II.A. Times for Performing the Sleep and Wake-Up Trades
   II.B. Parties and Entities
   II.C. Bonds for the Transaction
   II.D. Prices for the Trades and Variation Margin
   II.E. Final Settlement at Contract Expiry
   II.F. Margin
   II.G. Exploiting Existing Bilateral Collateral Agreements, Anonymous vs. Name Give-Up Trades
   II.H. Positions Held for Portfolio
   II.I. Accounting and Reporting
   II.J. Margin and facilities for reducing margin requirements
III. Electronic Trading and Trading Systems for Underlying Securities
   III.A. Clip Size Trades
   III.B. Curve and spread trades
   III.C. Order routing, exchangeability and substitutability
IV. Additional Embodiments
V. Conclusion

### I. OVERVIEW

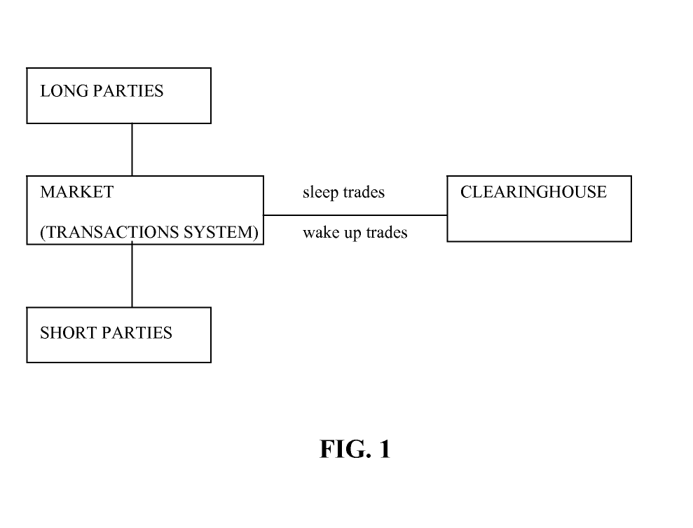

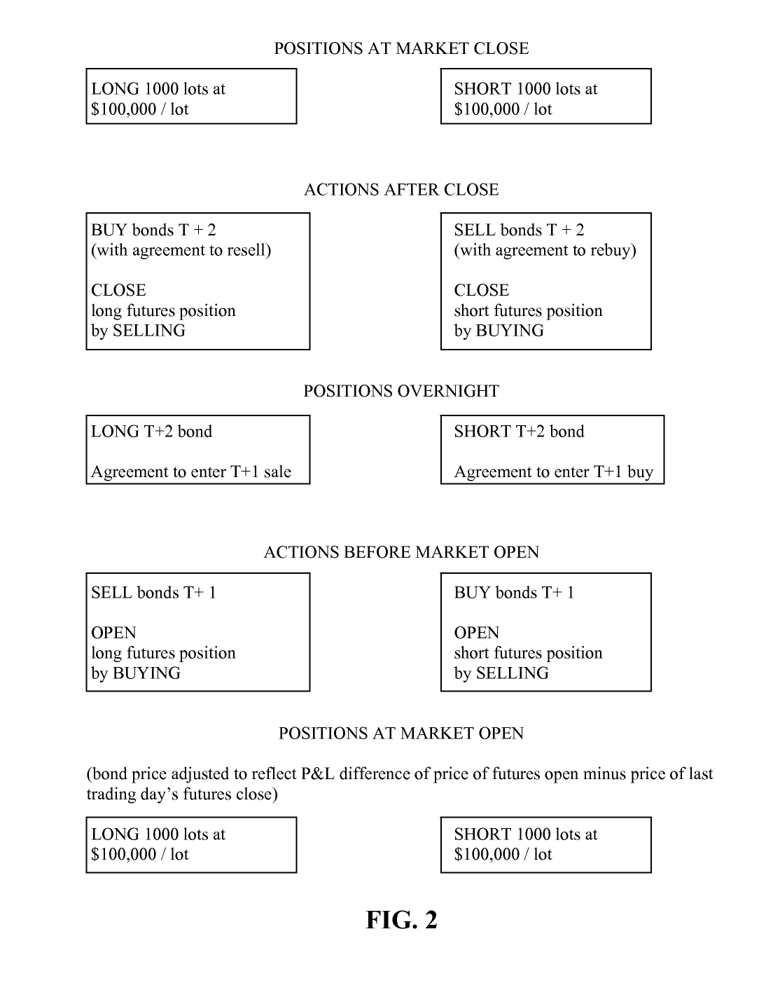

Referring to FIGS. 1 and 2, in an embodiment, a financial instrument transaction system that manages positions in and/or trading of one or more types of financial instruments (e.g. bonds, bond futures contracts, interest rate swaps, other securities, derivatives of any of the foregoing) is operable to “roll” (i.e. convert) positions in a first type of financial instrument into positions in a second type of financial instrument. Such rolling of positions may occur at various times (e.g. at one or more predetermined times, upon the occurrence of predetermined events, as commanded or specified by a user, from time to time). The financial instrument transaction system is also operable to then roll the positions in financial instruments of the second type back to the positions in financial instruments of the first type. In an embodiment, one of the two types of financial instruments is a derivative of the other, for example, the first type may be bond futures contracts, and the second type may be bonds (e.g. U.S. government bonds or other government or corporate bond issues, often referred to as “Cash bonds”). For discussion purposes, the roll from the first type (e.g. the derivative) into the second type (e.g. the financial instrument underlying the derivative) is referred to as “going to sleep,” and the roll back from the second type to the first type is referred to as “waking up.” As described herein, the identity of the bonds selected for the “sleep” trade, and the prices at which the “going to sleep” and “waking up” trades are entered, may be determined so that the risks and economics of the positions in the futures contract are embodied in the underlying bonds.

In one example embodiment (simplified for expository purposes), positions in bond futures contracts are put to sleep as bonds (e.g., “bonds”). Just after the close of the trading day, or at other times as convenient, the transaction system causes certain trades (e.g., all bond future contracts by traders who have agreed to such an arrangement) to be closed and instead booked with a Clearinghouse for subsequent settlement by a clearing agent for the underlying security (bonds), to thereby “put those futures positions to sleep.” At this time the futures positions are temporarily closed and replaced with bond trades. These bond trades may be registered with the Clearinghouse either (1) by an entity (e.g., a sponsor, owner, operator or manager of the transaction system) that acts as a principle to the trades or (2) by an entity that acts on behalf of the trade counterparties to register trades with the Clearinghouse on behalf of the counterparties, or (3) by the trade counterparties themselves when directed to do so by an entity (e.g., a sponsor, owner, operator or manager of the transaction system) that identifies the opposing counterparty to each transaction.

Referring to FIG. 1, a Market defines the interactions among various parties as coordinated by the transaction system. The Market allows, inter alia, parties to enter into long and/or short positions in various financial transactions. As is well known, a single party may be enter into several trades for different financial instruments with different counterparties. The Market, or particularly the transaction system, directs the Clearinghouse as described herein.

In an embodiment, to put a long position in a futures contract to sleep, the transaction system closes the futures position by way of a sell trade and also enters a “buy” trade of an amount of bonds equivalent to the notional value defined by that futures position. The buy order is for T+2 (i.e. Trade date plus two trading days) settlement, and the order is entered with the Clearinghouse (e.g. the Fixed Income Clearing Corporation division of the Depository Trust & Clearing Corporation) for subsequent settlement by the clearing agent (e.g. JPMorgan Chase or Bank of New York via the Fedwire clearance system). A “T+2” buy is a trade in which the parties to the trade agree that that each party will deliver its respective obligation on the trade to the clearing agent by a certain time (e.g. 3:00 PM) two trading days after the date of the trade. Thus, for a T+2 securities trade anytime on Monday, the buyer is obligated to deliver cash, and the seller is obligated to deliver securities, to the clearing agent by 3:00 PM Wednesday. The clearing agent would effect the transfer of the cash to the seller and the securities to the buyer Wednesday after 3:00 PM. To put a short position in a futures contract to sleep, the transaction system causes an opposite closure of the futures position by way of a buy trade and also enters a T+2 “sell” trade for a corresponding amount to be entered with the Clearinghouse for subsequent delivery via the clearing agent.

However, according to the same embodiment, after the transaction system puts the long position and the short position in the futures contract to sleep, the transaction system enters “reverse” trades into the Clearinghouse the morning of the next trading day. For example, the morning after the trade, the transaction system “wakes up” the long position in the futures contract by entering a buy trade for the futures that re-establishes that position and also entering into the Clearinghouse a T+1 sell trade of the bonds for the long party. Similarly, the transaction system “wakes up” the short position by entering a sell trade for the futures that re-establishes that position and also entering into the Clearinghouse a T+1 buy order of the bonds for the short party. After the T+2 and subsequent T+1 bond trades have been entered into the Clearinghouse, the bond trades may quickly novate into trades that are legally contracted between each counterparty and the Clearinghouse, rather than between the counterparties as originally traded. “Novation” here is a substitution of a new bond trade for an old bond trade, the old trade being extinguished by the new one contracted in its stead.

The T+1 “wake up” bond trade is entered a day after the trade, and so would settle on the same day as the corresponding T+2 “sleep” trade of the previous trading day. Therefore, in an embodiment, the Clearinghouse may net those two bond trades so neither will go to delivery via the clearing agent. Also, the long positions and the short positions in futures contracts are always matched—i.e. for every long counterparty that promises to buy under a long future, there is a short counterparty who promises to sell under a short future, and the two total quantities necessarily match exactly. When a futures position is effectively transferred into a bond position in the described manner the bond position also necessarily matches. Thus, in many situations, the transaction system need not cause delivery of any bonds via the clearing agent, and thus there may be little or no financing cost for the “sleeping” bond positions with the Clearinghouse

FIG. 2 illustrates states in an embodiment. In particular, for each of five times (five rows in FIG. 2) two states are described, one for a long position in a first instrument and one for a short position in a first instrument. The first time (at market close—first row in FIG. 2) illustrates long and short positions for a futures contract for 1000 lots at $100,000 per lot. At the second time (soon after the close of trading—second row in FIG. 2), the long position and short position of the futures contract are converted into corresponding buy and sell trades for bonds. At the third time (“overnight”, or well after the close of trading—third row in FIG. 2), the long and short positions in bonds are subject to an agreement to reverse around the time of the market open. At the fourth time (before the market opens—fourth row in FIG. 2), the positions in the bonds are reversed through sell and buy trades. At the fifth time (around the time of the open—fifth row in FIG. 2), upon the re-opening of the positions in the futures contract the T+1 bond trade price may be adjusted to reflect the difference, if any, between the closing and opening prices of the futures contract.

Because most of the economic risks of the future contracts can be embodied in the bonds during the “sleep” period, and thus are transferred to the Clearinghouse by the “sleep” trades, the operator of the transaction system holds relatively little market risk were a counterparty to the trades to default. The overnight risk of a counterparty default to the Futures market operator may also reduced as the bond Clearinghouse may effectively assume some of that risk.

In an embodiment two futures exchanges permit the trading of futures contracts on the same underlying product, but those contracts are not fungible due to them being cleared by different clearinghouses. For example, US Government bond futures traded on the Eurex US futures exchange were not fungible with US Government bond futures traded on the Chicago Board of Trade (CBOT). Using the above embodiment, an entity that has a long position in the Eurex Ten Year US Government bond futures contracts and also has a short position of an equivalent amount of CBOT Ten Year US Government bond futures contracts could put to sleep their Eurex US long position with the FICC bond clearinghouse and then enjoy up to 75% margin relief from their net bond position in FICC against their short position at the CBOT's clearinghouse. The up to 75% margin relief comes from an agreement between FICC and the CBOT's clearinghouse across similar futures classes. In other embodiments, the amount of margin relief between clearinghouses may be greater or less than 75%.

In another example embodiment (again simplified for expository purposes), positions in bilateral Interest Rate Swap contracts may be put to sleep as bonds and later woken up back into Interest Rate Swap contracts. Generally, an Interest Rate Swap (IRS) contract is an agreement between two parties to exchange interest payments on a periodic basis on a given principal amount. The IRS contract can sometimes be analogous to a bond in it's coupon cash flows, but only the interest on the principal amount of the IRS is exchanged; the principal amount of the IRS contract itself is not exchanged. One party to the IRS contract will pay the same interest rate determined at the start of the agreement, multiplied by the notional value of the contract. The other party will pay a rate of interest which varies over time and which is determined periodically based on regularly published indices (e.g. LIBOR—London Interbank Offered Rate, which is an average rate of quotes from the interbank market calculated for a range of popular benchmark interbank loan maturities), multiplied by the notional value of the contract. For example, a 100 million Ten Year US Dollar IRS contract (“from now to 10 years time”) with a fixed rate of 4.40% may have interest payments based on the principal amount of $100 million, with one counterparty to the IRS contract paying 4.40% per annum and the other counterparty paying the 6 Month LIBOR rate as determined every six months on $100 million. This exchange of payments typically occurs every six months for ten years (the maturity of that IRS contract). The payment flows mimic a Ten year maturity bond bought with borrowed money and refinanced every six months for then another six months.

A Ten Year maturity IRS instrument can also be analogous to a Ten year fixed interest Dollar deposit that has been deposited with money borrowed and refinanced every six months for then another six months.

The similarities between an IRS contract and bond payment flows can allow for an IRS contract to be “put to sleep” as a bond with, for example, a bond Clearinghouse. Counterparties typically accrue large bilateral portfolios of IRS trades with each other due to the structure of the market favoring liquid trading of yearly maturity bilateral IRS contracts (often called “tenor” or “term”). For example, a benchmark Ten Year IRS traded today is for a maturity of T+2 plus Ten Years but a similar benchmark Ten Year IRS traded in one week's time is for that date +2 plus Ten years: although both IRS are termed “Ten Year IRS,” because they are traded on different days they have different payment dates and thus cannot immediately be offset and cancelled. In the case of a preferred embodiment, IRS trades may be slept as a bond via a T+2 sleep trade with a T+1 wake up trade entered the following day, to allow large multiple portfolios of often disparate IRS trades outstanding bilaterally between counterparties to net down against each other overnight on account of being slept as one or more bonds. Preferably the counterparty default exposure between IRS counterparties may be substantially reduced due to the effective netting of the IRS trades via the novating of the bond sleep trades to a Clearinghouse.

In an embodiment, the IRS contract may be put to sleep as a bond when payments are due to effect those payments by means of the sleep and wakeup bond prices used. In another embodiment, the IRS contract may be slept as a bond more frequently when market movements require collateral or monies to be transferred from one counterparty to the other. In still further embodiments, the IRS contract may be slept at expiry (often called maturity) or premature expiry to engineer the necessary cash payments (premature expiry of an IRS contract is often called “Rip-UP” and is whereby a previously traded IRS contract is cancelled using current market values to determine a single final cancellation payment due from one counterparty to the other to prematurely end the previously agreed cashflows).

In the disclosed embodiments, there are many known ways that the trades may be entered into the clearinghouse. Trades may be entered as “Name-give-Up”, whereby the buyer and seller to the sleep trade are made known to each other and they send their trades to the clearinghouse directly. The operator of the transaction system (or another entity) may also become initial counterparty to the buy and sell trades acting as principal. Alternatively, the operator of the transaction system (or another entity) may enter the trades into the clearinghouse via an “introducing broker mechanism” whereby the trades are delivered to the clearinghouse without the entity actually becoming counterparty to either trade.

### II. FURTHER DETAILS AND ALTERNATIVES

II.A. Times for Performing the Sleep and Wake-Up Trades

In some cases, it may be preferable for the transaction system to put the positions to sleep relatively infrequently, because each trade entered with the Clearinghouse incurs transaction fees. Thus, during the day, the transaction system may book the trades (e.g. futures trades) during the trading day. At the end of the trading day, the counterparty's net trading positions can be calculated, and only the net position put to sleep as equivalent trades with the Clearinghouse. The counterparty default risk may lie with the operator of the transaction system for any positions not yet “slept” or effectively rolled to the Clearinghouse.

In some cases, it may be preferable to put most positions to sleep very quickly after a transaction of the futures position, or at an agreed time to allow the operator of the transaction system to more promptly transfer counterparty default risk to the Clearinghouse and effectively pay/receive mark-to-market monies between the counterparties. An inherent part of the service of the Clearinghouse is to hold counterparty default risk by quickly novating bilateral trades between counterparties to then be trades between the counterparties and the Clearinghouse, so quickly rolling positions into trades at the Clearinghouse may be desirable to effectively transfer this risk to the party whose very reason for existence is to hold such risk.

In many cases, the Clearinghouse for the underlying instrument (in the example, the bonds) will require that their customers (counterparties to trades) post margin (initial margin monies and/or securities to cover the risk of a newly opened position, and/or variation margin monies and/or securities to cover the mark-to-market profit or loss of a previously opened position) with the Clearinghouse to mitigate the Clearinghouse's risk of default by the customer. Because the counterparties for the transaction system will typically already have Clearinghouse customer margin accounts and margin lodged for bond positions with the Clearinghouse, the Clearinghouse's accounting and policies for margin can also accommodate bond trades forwarded by the transaction system, with at most relatively little change. In some cases the margin required at the Clearinghouse for a counterparty may be reduced by new trades in securities entered as a result of futures trades being “slept,” due to these new bond positions netting down that counterparty's opposing bond positions already existing at the Clearinghouse. Additionally, the margin positions held by the clearer for bond positions can often be offset against margin requirements for the same customer's futures positions at other futures exchanges, reducing margin costs for the customer.

In existing futures markets, the transaction system from time to time makes “intraday margin” requirements, typically at noon, to account for sudden market volatility and to collect and pay margin to effectively mark counterparty's positions to market intraday rather than wait for that night (often referred to as a “margin call” to pay and receive margin to and from counterparties during a trading day that has shown significant market movement). The transaction system may put positions to sleep intraday, rolling them to bond positions with the Clearinghouse to allow the operator of the transaction system to transfer counterparty default risk to the Clearinghouse and to pay and receive mark-to-market monies between the counterparties (equivalent to an intraday “margin call”). The trade may require a cash settlement amount (either positive or negative) in an amount that mirrors the amount of a traditional intraday margin call. In some cases the trade may even be immediately reversed to effect just that transfer of margin call monies, but via trades entered into the bond Clearinghouse.

II.B. Parties and Entities

In some cases, the bookkeeping, and particularly the obligation to enter the “wakeup” trades, may be lodged in a bankruptcy-remote special purpose entity that receives fees for performing this task. Because this entity is bankruptcy-remote from other entities, the wakeup trades will be entered even if other entities, for example the operator of the transaction system, goes bankrupt or otherwise defaults. In other cases, in the event of a default of the operator, the counterparties would wake up with the equivalent bond position previously novated to the Clearinghouse instead of the futures position from the close of the previous day.

II.C. Bonds for the Transaction

In some cases, the bonds identified by the parties for use in the embodiments are bonds that have a duration or DV01 (Dollar Value in price of a basis point change in yield of a bond) corresponding to the duration or DV01 of bonds that fall within the basket of bond issues that are acceptable for final delivery into the futures contract at contract expiry, within the specification of the bond contract. An example of such a futures contract would be bond futures contracts as traded on the Chicago Board of Trade (CBOT) that define a basket of substitutable bonds that may be delivered into the futures contract at expiry, with price adjustments for delivery of various different bonds in the basket. As used herein, the “duration” of a bond is the weighted average maturity of a bond's cash flows, DV01 is a property of a bond that expresses the price fluctuation of a bond relative to a change in underlying interest rate (DV01 tends to be higher for longer term and higher coupon fixed income bonds.) The identified bonds may be the most liquid in the futures contract's delivery basket, or bonds that well approximate the bond that is viewed by market counterparties as the cheapest-to-deliver of the basket at futures contract expiry. Multiple Bond issues may also be combined so that the average duration is at or near the desired duration. The bonds may be “on the run” (recently issued benchmark bonds) or “off the run” (older less liquid issues).

In some cases, a customer may designate the precise bond to be bought or sold into the sleep and wakeup transactions. In a typical exercise of this option, the customer may designate to sell overnight a bond he/she already holds long in his/her account at the Clearinghouse, or buy overnight a bond in which he/she holds a short position at the Clearinghouse. This permits the two positions to be netted off against each other for purposes of computing margin required by the Clearinghouse while the sleep trade is open.

In most cases, the bonds that are identified in the “wakeup” transaction for each counterparty will be exactly the same bonds as the bonds that are identified in the “sleep” transaction. In some cases, the “sleep” trade and the “wakeup” trade may be for different bonds, in the event that the holder of the futures contract wishes to adjust shift his inventory from one bond to another and a subsequent amendment is agreed for the wakeup trade. This amendment may take the form of a swap trade of one bond for another.

II.D. Prices for the Trades and Variation Margin

The transaction system may be structured so that daily “mark to market” price movement Profits and Losses (P&L) or variation margin are recognized by means of transaction pricing.

In some cases, the price for the “sleep” T+2 bond trade will be at the prevailing market closing price for the bond, with an adjustment (positive or negative) to cause recognition of P&L for futures price movements since the last sleep or wakeup trade that caused a P&L recognition.

In some cases, the price for the “wakeup” trade may be at a bond price calculated from the futures market opening price to cause recognition of P&L for overnight futures contract price movement. For example, if a futures closing price is 108% for 100 lots of $100,000 contract size and the sleep bond equivalent trade is priced at 109.5% for a bond size of $9,500,000 nominal value; the wakeup price of the bond trade needed to equate P&L incurred from a futures opening price the next day of 108.5% [futures contract P&L=(108.5-108) %×100×$100,000=$50,000] would be 109.5%+$50,000/$9,500,000=110.002631%. The wakeup futures price may then be the opening price of 108.50% as the P&L has been paid/received between the long and short counterparties from the bond sleep and wakeup trades. The wakeup bond trade price may thus be adjusted, or intra-day put-through trades (same day buy and sellback trades) may be entered, to recognize P&L of day's futures price movements via the bond Clearinghouse, and/or to effectuate intra-day margin calls.

II.E. Final Settlement at Contract Expiry

In some cases, a futures contract traded on the transaction system may be defined to require delivery of a particular bond or a choice from a basket of bonds at contract expiry, analogous to a Chicago Mercantile Exchange (CME) futures contract for treasury bonds. In other cases, the contracts traded on the transaction system may specify cash settlement, in which counterparties pay and receive monies directly according to an expiry value of the futures contract usually ascertained in reference to, but without any actual delivery of, referenced underlying securities or bonds. In still other cases, on expiry, the short futures counterparty may be required to deliver a specified bond to the long futures counterparty. In such cases, the transaction system may allow for the substitution of a bond sleep trade into this final settlement process.

II.F. Margin

In some of the embodiments above, where a futures contract position is slept as a bond position at the bond Clearinghouse for a counterparty, the required margin at the Clearinghouse (from the counterparty) may be affected by the introduction of the new bond position. For example, modem bond Clearinghouses charge initial margin to cover risk on new positions but their systems mostly calculate overall margin requirements on a net Value-at-Risk (VAR) calculation applied to the counterparty's aggregate bond “book” of all individual bought (long) and sold (short) bond issue positions. Additional bond positions introduced into counterparty's aggregate bond book, as a result of a futures position sleeping as a bond position, may thus increase, decrease or leave unchanged that counterparty's net VAR For example, if a counterparty has a net long bond position at the clearinghouse, the introduction of an additional long bond position would be expected to increase the margin calculated from the net VAR on their aggregate bond book. If a short position were introduced from a futures position sleeping as a bond position then the net VAR on their (net long) bond book would be expected to decrease. If that additional short position was opposite to an existing long position in an exact bond issue in the counterparty's aggregate net long position, then the net VAR reduction would be expected to be particularly effective.

II.G. Exploiting Existing Bilateral Collateral Agreements, Anonymous vs. Name Give-Up Trades

A sizeable fraction of all futures trades occur between counterparties that have existing bilateral collateral agreements as a result of other business traded bilaterally between them. This is where a counterparty posts cash or securities with another counterparty as collateral to secure future payments due. The transaction system may exploit the existence between counterparties (e.g. banks and securities firms) of an extensive web of these agreements, for example, by allowing futures positions to be slept as trades in other instruments (derivatives or securities) bilaterally between the long and the short counterparties in order to avoid transaction fees involved in novation with a Clearinghouse. In this embodiment the transaction system may effect the sleep trades as “Name-give-up” whereby the opposing futures long and short counterparties are given up to each other for the purpose of the sleep trade and thus provide lower transaction fees for such trades. Counterparties may also bilaterally elect to hold the positions in “sleep” condition rather than reversing them into “awake” condition to further minimize transaction fees as their daily mark-to-market bilateral risk between them may be covered by the collateral agreements already in place and being regularly adjusted as a result of other business between the counterparties

Thus, in some cases, for example, where the trading parties are relying on bilateral agreements, the sleep trades and/or even the original trades done on the transaction system may be on a name-give-up basis. In most circumstances, trading may occur on an anonymous basis, especially prevalent when a Clearinghouse is used for the sleep trades.

In some cases, the operator of the transaction system, the trading parties, and/or the special-purpose entity discussed in herein, may own and operate a computer system that is a trusted repository of credit and inter-counterparty collateral agreement information. This system may hold credit information in a database in a way does not permit anyone other than the owner of each particular datum to review it or change it, but does permit those limited queries that are necessary to identify counterparties to each other that may prefer to use bilateral collateral agreements to secure name-give-up sleep trades rather than novating to a clearinghouse. The server may permit a “yes/no” query by the party seeking a trade, to confirm the eligibility of the counterparty to do the trade against the querying party's credit and other qualification information. A sequence number on each order may be used by this trusted computer to identify the owner of the order to permit credit qualification by the server.

Alternatively, each order in the transaction system may have a tag identifying the party who entered the order, and the tag may be generated individually for each order, or otherwise be made to be anonymous, so that the tag does not reveal the identity of the owner of the order, but does identify the order sufficiently to permit the server to suggest collateral agreements may be used for positions between counterparties for sleep trades either in alternative instruments (for example short term interest rate swaps) or in the original security or futures contract traded, secured by those collateral agreements in place.

II.H. Positions Held for Portfolio

In some cases, especially when the customer indicates that he may hold the futures position for some time (as opposed to traders who may hold the position for seconds or up to a day), the futures position may be agreed between counterparties to be put to sleep as a fairly long “forward” trade (a forward trade is one whereby settlement is agreed to be a non-standard date later than the agreed market standard for usual conventional trades in an instrument), for example, up to T+22 (Trade date plus twenty two business days), to “wake up” up to a month hence (there are often typically 22 trading days in a calendar month), or earlier if the futures position is closed. For example a position may be put to sleep as a T+22 bond trade and stay as a bond trade every day (not wake up as a futures trade again) unless it is closed by the counterparty, precipitating a wakeup reversal trade upon closure. If the counterparty has not closed his futures position in the market that day the next morning it stays asleep as a cash trade until 21 business days later when it must necessarily wakeup as a T+1 trade for the last trading day of the cycle whereby that cycle may then start again. This may provide certain advantages for the transaction system whereby matching of sleep trades between counterparties may be optimized.

II.I. Accounting and Reporting

In some cases, the transaction system may be arranged using a financial instrument such that the “sleeping” position is reportable for financial accounting, tax accounting, debt or asset ratio covenants, Securities and Exchange Commission regulations, Commodities Futures Trading Commission regulations, and other reporting and accounting purposes as an off-balance-sheet asset, booked in a manner analogous to other off-balance-sheet futures contracts. In other cases the transaction system may be arranged in a financial instrument so that the “sleeping” position is reportable as an on-balance-sheet item to advantageously manage counterparty risk.

In some cases, some of the counterparties may be FCM's (Futures Commission Merchants, those merchants involved in the solicitation or acceptance of futures contract orders, and having the ability to extend credit to those who place such orders and facilitate clearing of their obligations) regulated by the Commodities Futures Trading Commission (CFTC). In some cases, FCM's may sleep futures trades as a series of bonds designated by the operator of the financial instrument transaction system on behalf of their customers. In other cases the FCMs may elect to sleep futures trades as different instruments on behalf of their customers than when trading on behalf of their own accounts. In some cases, the FCM may obtain a limited power of attorney or similar consent to enter the sleep/wakeup trades on the customers' behalf. In other cases the FCMs may enter the sleep/wakeup trades only on the FCM's overall net futures contract positions resulting from when their individual customer's positions are netted against each other.

II.J. Margin and Facilities for Reducing Margin Requirements

Various clearers and trading parties have arrangements for “cross margining” of offsetting positions held in different accounts. For example, if a party holds bonds long at FICC (Fixed Income Clearing Corporation, the clearer for bonds) and short futures for similar bonds at CME Clearing (Chicago Mercantile Exchange, the clearer for bond futures), the two may have an agreement that permits the two positions to be offset against each other so that the total margin required may be reduced by an amount that may be up to 75%. The transaction system may enter cross-margining agreements with other clearers for traditional cross margining relief between futures and bonds, and/or futures to futures. Alternatively, or additionally, the transaction system may use a sleep as cash procedure for futures trades such that the cross margining of the bond Clearinghouse is effectively leveraged automatically. The transaction system may provide a facility as shown in FIG. 6, available throughout the trading day, to allow dealers to put their futures positions to sleep through an EFP (exchange for physical) for physical (cash) bonds of their choice on a T+2 basis, with an agreed T+1 reversal the next morning as described herein. Use of this facility may permit dealers to improve use of margin already held by FICC against bond positions for cross margining against futures positions held at CME Clearing, or to reduce margin needed at FICC for opposing physical or futures positions. This “sleeps-as-cash” facility (bonds are sometimes referred to as “cash bonds,” sometimes shortened to just “cash”), to effectively transfer positions into FICC bond positions overnight, may be provided for dealers to buy or sell specific bonds against selling or buying futures contracts, at current market levels.

Referring to FIG. 6, the transaction system, or an associated bond trading system, may list a series of bond/futures pairs so dealers looking for futures positions to be “slept as cash” in certain bonds may bid/offer for the pairings at current market spreads as indicated on the system. A reserve size functionality may be useful in arranging such trades at a favorable price without showing to the marketplace the full size of the desired trades (a reserve size functionality may preferably add size to a trade once that trade has been agreed to facilitate a larger trade without initially disclosing the full nature of the counterparty's intent). The current market price spread may be expressed as a traditional “basis” price (the trading of the spread between a futures contract and a bond is called “basis trading”) using previously published conversion factors to convert a futures price into an equivalent bond price, and the number of futures contracts exchanged per million of each bond in the Exchange for Physical trade (“EFP” trade; market parlance for trades where futures are exchanged for bonds, often termed as “physical” bonds) may be controlled by a published hedge ratio that is equivalent to the DV01 of the bond divided by the DV01 of the futures to give a fair risk equivalent amount of bond and futures on the trade. Herein the DV01 of the futures may be calculated as the DV01 of the most likely bond to be delivered at futures contract expiry (the “cheapest to deliver” bond) on its most likely delivery date, then divided by its conversion factor. The published conversion factor for a specific bond is mostly calculated as the price of the bond at a yield of a particular value (often 6%), calculated for the futures delivery day, as defined by a futures contract specification.

Counterparties can thus transfer exposure out of the transaction system to bond positions held at a Clearinghouse to:
Net down specific bond positions at the Clearinghouse to remove a particular position from the Clearinghouse's Value-at-Risk margin calculations.
Trade a selection of bonds to minimize the Clearinghouse margin requirement by using the new bond position to offset against aggregate net long or net short Clearinghouse bond positions.
Effectively transfer margin obligations from the transaction system into the counterparty's requisite Clearinghouse margin, using that increased Clearinghouse margin as then eligible for cross margining against other aggregate futures clearing positions at another futures exchange Clearinghouse.

Thus the facility provides a secure and cost effective way for participants to manage aggregated net positions to minimize margin requirements on the transaction system where their balance sheet considerations are not limiting.

### III. ELECTRONIC TRADING AND TRADING SYSTEMS FOR UNDERLYING SECURITIES

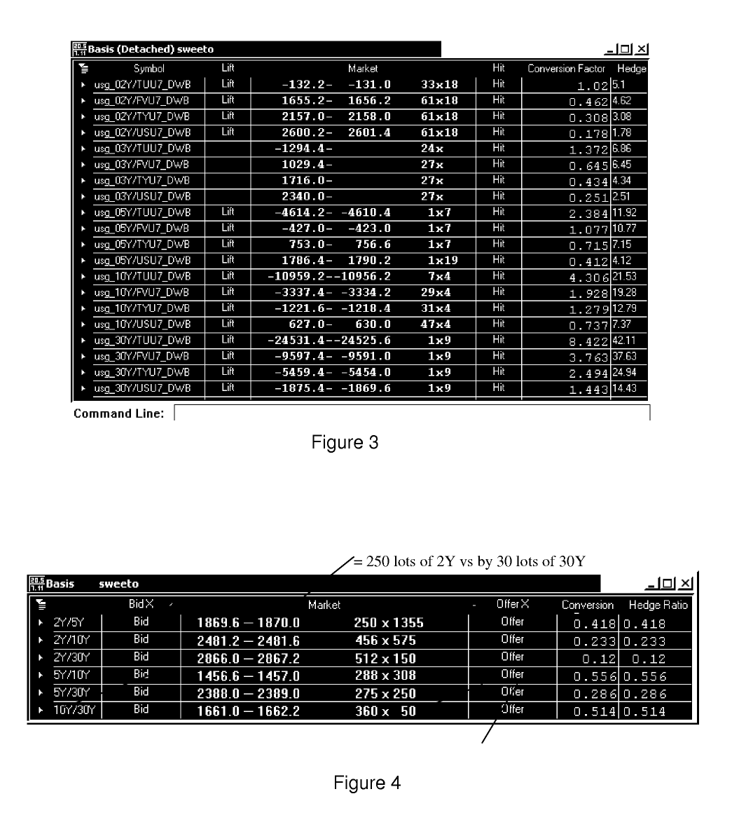

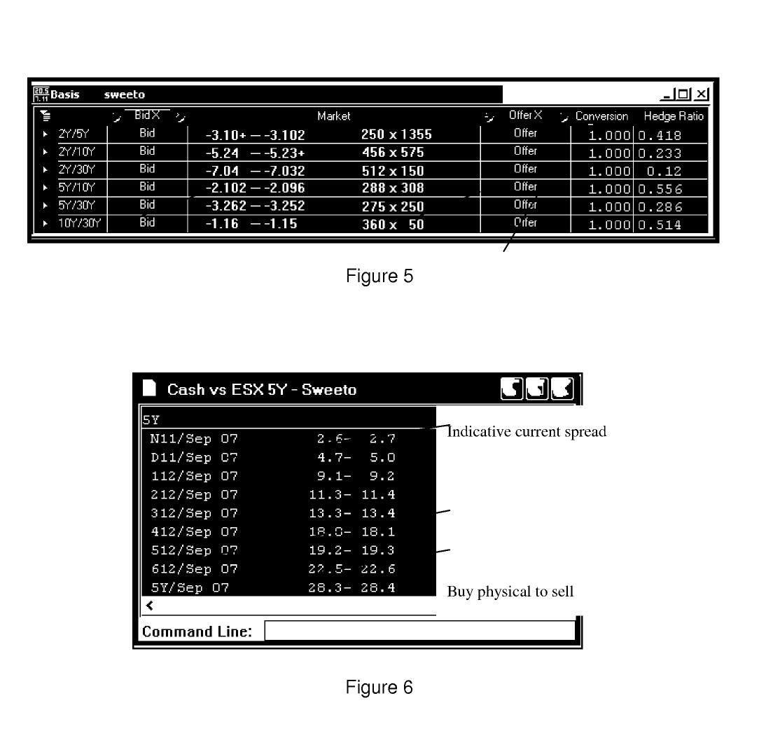

Referring to FIG. 3, there may be synergies if a futures transaction system is hosted with, or has ready ability to cooperate with, a transaction system for the underlying or “sleep” security. The relationship between two instruments that determines the market prices at which one trading position may be “slept as another” trade position in an alternative Clearinghouse venue may itself be traded between the two marketplaces. The trading of the spread between a futures contract and a bond is called “basis trading” whereby opposing long and short positions of each instrument may be entered into, in order to attempt to profit on their price convergence or divergence characteristics over time. Two securities may be traded on the same exchange as a basis trade whereby the exchange facilitates the simultaneous trade in both instruments between contra-counterparties (e.g. of a bond or other instrument against a futures instrument), in which the parties trade each instrument at a relative price difference of the two instruments in the expectation that at some future date the difference between the relative market prices of the two instruments (the “basis”) on that date will change—one party benefits if the first instrument does better than the second relative to the initially traded price, and the other party benefits if the second instrument does better than the first. If the exchange facilitates basis trading and/or has access to be able to electronically trade each component instrument to effect such basis trades on individual markets then the exchange may use market data (e.g. the end of day settlement price of the futures contract as published by the futures exchange and an equivalent end of day price for the bond) from such trading to accurately price sleeps-as-cash trades at then current market price levels to more effectively equate futures risk with the sleep bond trade risk.

Counterparties may be permitted to bid and offer basis trades that set off trades in instruments from the two classes against each other, for example, the derivatives against the underlying instrument, or U.S. Treasury bonds against US Treasury futures. These basis trades may be bid or offered as a composite “instrument” tradable on the electronic trading system (whereby trades on that instrument would precipitate two or more trades in each of the underlying instruments), to attract contra markets. Counterparties may also permit a system to attempt to execute a basis order between the component bond and futures components individually but substantially simultaneously.

An automated transaction system may also list composite basis instruments of bonds against longer or shorter duration futures which may use a conversion factor that has been weighted according to the differences in DV01 of the component instruments to give a “basis” price reflecting the cash/futures difference that is less influenced by outright up or down market movements.

III.A. Clip Size Trades

Where an exchange facilitates basis trading between counterparties, and where the exchange supports trading a basis order in the component bond and futures markets for substantially simultaneous execution an automated transaction system may support “clip trades” or clip size orders. “Clip orders” are designed to increase functionality for simultaneously executing trades between two markets. “Clips” are a series of quantity levels that allow the counterparty or automated system to define specific amounts, or “clips”, of an overall order to be traded. The counterparty or automated system specifies a clip order ratio, and the ratio defines the clip sizes that order may be traded in. For example, if a minimum tradable size of one million face amount of the bond component of a basis trade equates to an equivalent of 9.7 futures contracts, and if an order is to sell 97 futures contracts in clips of 9.7 contracts is worked in a futures trading system against simultaneously selling 10,000,000 nominal of the bond in the bond trading system (to give a properly weighted basis trade such that the DV01 of the component futures contract trade is equivalent to the DV01 of the bond trade); that futures order is subsequently tradable by the system in amounts (clips) of only 10, 20, 29, 39, 49, 58, 68, 78, 87 and 97 contracts. The result is that any futures trade will then be in a size that equates to $1 million, $2 million, $3 million nominal etc of the bond that is only tradable in round amounts of $1 m nominal, thus allowing for an optimal weighting of such basis trades when individually traded in both markets substantially simultaneously.

In some cases, a clip size order may be placed by an automated transaction system as resting futures orders on a futures exchange (that is, limit bids that are at a price at or below the prevailing market price, or limit offers at a price at or above the market, which therefore do not trade immediately but rest on the market's book waiting for a price movement in their direction) which may be left “leaning” against a linked bond order on a bond exchange or marketplace, to trade both simultaneously. When the futures order is completely traded or partially traded according to its prescribed clip size the corresponding bond order is also traded substantially simultaneously in an equivalent amount. When a clip sized order exists at the best price and is partially traded, the electronic trading system may in some cases cancel the remaining clip sized order if a contra order could then trade at that price level but not in the full clip size needed. For example, if a resting clip sized bid order is alone at a bid price of 101.00 for 97 contracts in clip sizes of 9.7 contracts, and a contra 101.00 sell order in any size of less than 97 lots except 10, 20, 29, 39, 49, 58, 68, 78 is entered, the clip sizes can trade but remainder cannot. The trading system may then preferably remove the remaining clip size order.

III.B. Curve and Spread Trades

In some cases, a further composite derivative instrument may be defined and traded, as an instrument that denotes the spread between the contract traded on the transaction system and another economically-similar instrument, for example, the spread between a five year equivalent bond futures contract and a ten year equivalent bond futures contract, traded on the transaction system. Such a derivative instrument may be referred to as a “spread” instrument. The round amount tradable for this spread instrument may be set to be correspond to the minimum amount of one of the contracts (the Five year bond futures contract lot size for example) that equates to a corresponding amount of the other futures contract. For example, in order to be correctly weighted according to their individual DV01 numbers, 5 contracts of the five year bond futures contract would be traded with 3 contracts of the ten year bond futures contract; thus this spread contract would be tradable in round amounts of 5 contracts of the five year bond futures contract versus 3 lots of the ten year bond futures contract. Where an automated transaction system attempts to execute orders in such spread instruments by simultaneously executing trades in both component contracts, clip sized orders would be particularly helpful.

Referring to FIG. 4, automated trading system technology may be used to offer a market and to trade in both futures contracts described above with paired order execution used to create linked orders. For example, a trading system's linking feature may be used to link a five year bond futures contract order and a ten year bond futures contra order into a single transaction for substantially simultaneous execution. Popular or highly-liquid pairs of futures may be featured as listed spreads, for another example a 2-year/30-year futures spread in an 8 contract to 1 contract ratio. Where automated trading system technology attempts to execute spread orders of this nature it is preferable to utilize clip sized orders to adhere to the prescribed 8:1 ratio.

Where a counterparty has positions resulting in a futures calendar spread (a futures calendar spread is where a counterparty has opposing long and short positions in two futures contracts that have different maturities but identical futures contract specifications, or where a composite instrument to trade such positions is listed on a futures exchange or financial instrument transaction system), traditionally, margin relief may be given by a futures exchange whereby lower margin is required due to the almost equally offsetting nature of each position. In some cases this long one contract versus short another contract “spread” position may be slept-as-cash on some proportion of the net exposure of the spread trade. In other cases the spread position's individual component long and short positions may be each slept as cash individually and either the net of both sleep trades entered into the Clearinghouse or both trades entered so the Clearinghouse can accommodate with their preferred net margining procedure.

III.C. Order Routing, Exchangeability and Substitutability

Although the above invention creates considerable advantages in margin reduction across similar asset classes, price convergence and economic equivalence between contracts traded on an exchange using the above-described mechanisms and other competing exchanges (offering economically similar but non-fungible contracts) may be further improved by smart order routing. In some cases, a customer may require that a futures order be traded on a specific exchange, or may specify that the order be preferentially routed to whichever venue has the better price, shorter routing time, or other considerations. Preference factors for smart order routing may include the following:
Preferred first exchange
Routing Price Delta (a counterparty's perceived price offset between one exchange instrument of contract versus another exchange's instrument or contract)
Routing Trigger (a number that defines the number of increments a resting order must be within the best bid price or best offer price on the first exchange before any part of it is routed to the second exchange).
Routing Percentage (% of an order untraded on the first exchange when subjected to the routing trigger that the counterparty would then prefer to see routed to the second exchange)
Routing Delay (once triggered the time delay down to milliseconds that any part of the unexecuted order should exist on the first exchange before going to second exchange)

### IV. ADDITIONAL EMBODIMENTS

In some cases for a sleeps-as-cash trade, bonds may be actually be borrowed from counterparties outside the transaction system overnight to facilitate a regular T+1 sleep trade and a T+0 (same day delivery) reversal trade that would be effected via the counterparty's clearing agent (e.g. JPMorgan Chase or Bank of New York). This permits the initiating sleep trades to be entered with the clearer as T+1 settlement, but requires financing costs to be paid among the parties and to the lender who lends bonds into the transaction system.

### V. CONCLUSION

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. In many cases, one feature or group of features may be used separately from the entire apparatus or methods described. Many of those undescribed variations, modifications and variations are within the literal scope of the following claims, and others are equivalent.

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

1. A method, comprising the steps of:
by electronic trading system for trading bond future contracts, communicating orders to trade the bond futures contracts among bond futures traders, and receiving acceptances of orders from the traders to result in executed bond futures trades and resultant bond futures positions; and
from time to time on a plurality of occasions and under management of the trading system pursuant to a contractual relationship among the traders and the operator of the trading system, by computer purchasing or selling bond positions economically equivalent to a traders' positions in bond futures and relieving the traders of delivery obligations under the bond futures contracts, and later reselling or repurchasing bonds and reestablishing the delivery obligations under the bond futures contracts.

2. The method of claim 1, in which the occasions from time to time include occasions at a regularly scheduled time of day.

3. The method of claim 2, in which the purchasing or selling is performed about at the close of each trading day, and the reselling or repurchasing is performed about at the opening of each trading day.

4. The method of claim 1, in which the bonds determined to be economically equivalent to the bonds futures contract are determined by steps including:
for each of the positions in bond futures contracts, determining a DV01 (DV01 of an instrument being the change in value of the instrument per one basis point change in yield of the instrument) of at least one bond that is acceptable for final delivery into the respective bond futures contract; and
for each of the positions in bond futures contracts, determining the corresponding bond by selecting a bond having a DV01 approximately equal to the determined DV01.

5. The method of claim 1, in which time to time is determined to manage risk held by an operator of the trading system.

6. The method of claim 1, in which prices for purchase or sale of the bonds are set to recognize profit and loss in the bond futures contracts.

7. The method of claim 1, wherein the bonds purchased or sold pursuant to the contractual relationship are selected by a party to the bond futures contract.

8. The method of claim 1, in which a quantity of bonds purchased or sold pursuant to the contractual relationship is related to a quantity of futures positions approximately in the ratio of the DV01 (DV01 of an instrument being the change in value of the instrument per one basis point change in yield of the instrument) of the bonds to the DV01 of the futures positions.

9. The method of claim 1, in which entering, with a clearinghouse for the purchasing or selling transactions, a buy trade and a sell trade for the bonds comprises:
entering, with the clearinghouse, a buy trade for T+2 settlement (trade date plus two days) and a sell trade for T+2 settlement for the bonds.

10. The method of claim 1, in which entering, with a clearinghouse for the purchasing or selling transactions, the later reselling trade and the later repurchasing trade for the bonds comprises:
entering, with the clearinghouse, a sell trade for T+1 settlement (trade date plus one day) and a buy trade for T+1 settlement for the bonds.

11. The method of claim 1, wherein the bonds purchased or sold pursuant to the contractual relationship are chosen to have a duration approximately equal to the duration of the bond futures.

12. The method of claim 1, wherein the bonds purchased or sold pursuant to the contractual relationship are chosen to have a DV01 (DV01 of an instrument being the change in value of the instrument per one basis point change in yield of the instrument) approximately equal to the DV01 of the bond futures.

13. The method of claim 1, in which a price for the later reselling trade or later repurchasing trade is calculated based on a then-current price of a bond futures contract.

14. The method of claim 1, in which the contractual relationship specifies that the bond positions are positions in bonds drawn from baskets of bond issues specified within the terms of the respective bond future contracts.

15. The method of claim 1, wherein the second instruments are traded for T+n delivery (delivery n days after the trade date), then m days later for T+n−m delivery.

16. A non-transitory computer memory, having stored therein program instructions to cause an electronic trading system to:
communicate orders to trade bond futures contracts among bond futures traders, and receive acceptances of orders from the traders to result in executed bond futures trades and resultant bond futures positions; and
from time to time on a plurality of occasions and as a component of a contractual relationship among the traders of the trading system and the operators of the trading system, purchase or sell bonds economically equivalent to a trader's position in bond futures and relieve the trader of delivery obligations under the bond futures contract, and later resell or repurchase the bonds and reestablish the delivery obligations.

17. The non-transitory computer memory of claim 16 wherein time to time is a regularly scheduled time of day.

18. The non-transitory computer memory of claim 17, wherein the purchasing or selling is performed about at the close of each trading day, and the reselling or repurchasing is performed about at the opening of each trading day.

19. The non-transitory computer memory of claim 16 wherein time to time is determined to manage risk held by an operator of the trading system.

20. The non-transitory computer memory of claim 16, wherein prices for purchase or sale of the bonds are set to recognize profit and loss in the bond futures contracts.

21. The non-transitory computer memory of claim 16, wherein a quantity of bonds transferred pursuant to the contractual relationship is computed relative to a quantity of futures positions approximately in the ratio of the DV01 of the bonds (DV01 of an instrument being the change in value of the instrument per one basis point change in yield of the instrument) to the DV01 of the futures positions.

22. The non-transitory computer memory of claim 16, wherein the bonds transferred pursuant to the contractual relationship are chosen to have a duration approximately equal to the duration of the bond futures.

23. The non-transitory computer memory of claim 16, wherein the bonds transferred pursuant to the contractual relationship are chosen to have a DV01 (DV01 of an instrument being the change in value of the instrument per one basis point change in interest rates) approximately equal to the DV01 of the bond futures.

24. The non-transitory computer memory of claim 16, wherein the bonds transferred pursuant to the contractual relationship are selected by a party to the bond futures contract.

25. The computer network of claim 16, wherein the bonds are traded for T+n delivery (delivery n days after the trade date), then m days later for T+n−m delivery.

26. A method, comprising the steps of:
on an electronic trading system for trading assets of an asset type, executing trades among traders of assets of the traded asset type, the traded asset type being a derivative of an underlying asset type;
from time to time and as a component of the contractual relationship among the traders of the trading system and the trading system, transferring traders' positions in the traded asset type into positions in the underlying asset type for a period of time, and later transferring the positions in the underlying asset claims back into positions in the traded asset type.

27. The method of claim 26, wherein the asset type is bond futures contracts, and the underlying asset type is bonds.

28. The method of claim 27, wherein prices for purchase or sale of the bonds are set to recognize profit and loss in the bond futures contracts.

29. The method of claim 27, wherein a quantity of bonds transferred pursuant to the contractual relationship is computed relative to a quantity of futures positions approximately in the ratio of the DV01 of the bonds (DV01 of an instrument being the change in value of the instrument per one basis point change in yield of the instrument) to the DV01 of the futures positions.

30. The method of claim 27, wherein the bonds transferred pursuant to the contractual relationship are chosen to have a duration approximately equal to the duration of the bond futures.

31. The method of claim 27, wherein the bonds transferred pursuant to the contractual relationship are chosen to have a DV01 (DV01 of an instrument being the change in value of the instrument per one basis point change in yield of the instrument) approximately equal to the DV01 of the bond futures.

32. The method of claim 27, wherein the bonds transferred pursuant to the contractual relationship are selected by a party to the bond futures contract.

33. The method of claim 26 wherein time to time is a regularly scheduled time of day.

34. The method of claim 26, wherein the purchasing or selling is performed about at the close of each trading day, and the reselling or repurchasing is performed about at the opening of each trading day.

35. The method of claim 26 wherein time to time is determined to manage risk held by an operator of the trading system.

36. The computer network of claim 26, wherein the underlying assets are traded for T+n delivery (delivery n days after the trade date), then m days later for T+n−m delivery.

37. A non-transitory computer memory, having stored therein program instructions to cause an electronic trading system to:
execute trades among traders of assets of the traded asset type, the traded asset type being a derivative of an underlying asset type;
from time to time and as a component of the contractual relationship among the traders of the trading system and the trading system, transfer traders' positions in the traded asset type into positions in the underlying asset type for a period of time, and later transfer the positions in the underlying asset claims back into positions in the traded asset type.

38. The non-transitory computer memory of claim 37, wherein the asset type is bond futures contracts, and the underlying asset type is bonds.

39. The non-transitory computer memory of claim 38, wherein prices for purchase or sale of the bonds are set to recognize profit and loss in the bond futures contracts.

40. The non-transitory computer memory of claim 38, wherein:
a quantity of bonds transferred pursuant to the contractual relationship is computed relative to a quantity of futures positions approximately in the ratio of the DV01 of the bonds (DV01 of an instrument being the change in value of the instrument per one basis point change in interest rates) to the DV01 of the futures positions.

41. The non-transitory computer memory of claim 38, wherein the bonds transferred pursuant to the contractual relationship are chosen to have a duration approximately equal to the duration of the bond futures.

42. The non-transitory computer memory of claim 38, wherein the bonds transferred pursuant to the contractual relationship are chosen to have a DV01 (DV01 of an instrument being the change in value of the instrument per one basis point change in interest rates) approximately equal to the DV01 of the bond futures.

43. The non-transitory computer memory of claim 38, wherein the bonds transferred pursuant to the contractual relationship are selected by a party to the bond futures contract.

44. The non-transitory computer memory of claim 37 wherein time to time is a regularly scheduled time of day.

45. The non-transitory computer memory of claim 37, wherein the transferring is performed about at the close of each trading day, and the later transferring back is performed about at the opening of each trading day.

46. The non-transitory computer memory of claim 37 wherein time to time is determined to manage risk held by an operator of the trading system.

47. The non-transitory computer memory of claim 37, wherein the underlying assets are traded for T+n delivery (delivery n days after the trade date), then m days later for T+n−m delivery.

48-67. (canceled)

68. A method, comprising:
executing, by a computer of a trading system, trades of bond future contracts to establish and sell positions in the futures contracts;
after approximately the end of a first trading day, for each of several positions in the bond future contracts held by traders in the bond trading system, by a computer of the trading system:
determining a respective bond and a respective price for the bond based on a price of the bond future contract, and
transferring the position in the bond future contract into a corresponding position in the respective bonds; and
approximately at the beginning of a second trading day, in which the second trading day is the soonest trading day that is after the first trading day, for each of several positions in the bonds, by a computer of the trading system:
determining a respective price of the bond and a respective price of the bond future contract, and
transferring the position in the bonds back into a corresponding position in a bond future contract.

69. The method of claim 68, in which transferring the position in the bond future contract into a corresponding position in bonds comprises:
entering, with a clearinghouse, a trade for the bonds for T+N settlement (trade date plus N days), in which N is an integer greater than ‘1’; and
closing the position in the bond future contract.

70. The method of claim 68, in which transferring the position in the bonds back into a corresponding position in a bond future contract comprises:
entering, with a clearinghouse, a trade for the bonds for T+N settlement (trade date plus N days), in which N is an integer greater than ‘0’; and
opening the position in the bond future contract.

71. The method of claim 68, in which transferring the position in the bond future contract into a corresponding position in bonds comprises:
entering, with a clearinghouse, an trade for the bonds for T+N+1 settlement (trade date plus N+1 days);
and in which transferring the position in the bonds back into a corresponding position in a bond future contract comprises
entering, with a clearinghouse, an trade for the bonds for T+N settlement, in which N is an integer greater than ‘0’.

72. The method of claim 68, in which determining a respective bond for each of several positions in the bond future contracts, comprises:
receiving, from a party to the bond future contract, a selection of a bond to be the respective bond.
